(19) United States
(12) Patent Application Publication
(10) Pub. No.: US 2015/0006540 A1
(43) Pub. Date: Jan. 1, 2015

(54) DYNAMIC MEDIA DIRECTORIES

(71) Applicant: Avid Technology, Inc., Burlington, MA (US)

(72) Inventors: Randall Martens, Littleton, MA (US); Eric Reesman, Arlington, MA (US)

(21) Appl. No.: 13/929,017

(22) Filed: Jun. 27, 2013

(51) Int. Cl. G06F 17/30

(52) U.S. Cl. CPC G06F 17/30321
USPC 707/741

(57) ABSTRACT

Methods and systems for managing media in a media editing environment enable automatic updating and relinking to media files stored in user-designated directories. The methods include maintaining an index for the media files stored in the designated directories, the index having an entry for each media file, each entry including a unique identifier for the file, and pointers to a metadata file pertaining to the media file and to the media file itself. A media editing application uses the index to access the metadata files which provide information about the corresponding media files that is displayed in the editor user interface. The designated directories may be on storage devices local to the system hosting a media editing application, or on shared storage connected via a local area network, or on remote or cloud-hosted storage. The media editing application monitors the index and updates the user interface to reflect any changes.

### BACKGROUND

In all but the very simplest of media editing projects, a user builds up a composition from a variety of media elements. Such elements may originate from one media source, such as a particular video camera during a particular shoot, from the same source during multiple different shooting sessions, or from multiple sources. The media may consist of different media types, such as video, audio, and special effects, each of which may exist in one or more formats or levels of quality. In many projects, the media may be supplied by different parties, such as a cameraperson or camera crew or an audio recording engineer, or it might be retrieved from a media archive. With several different individuals or teams working on a project, the available media may be subject to frequent changes, both with the addition of new material or the deletion of obsolete or unneeded material and with the replacement of existing media with an edited version or a version at a different quality. Furthermore, the media may be stored in various locations on a given system, or on multiple systems that share the same local network, or are distributed across a wide area network.

To enable media editors to handle such a range of media element types, locations, and versions, systems for managing and editing digital media need to provide users with an ability to identify the media that is currently available to them for editing a particular project or composition, and to facilitate incorporation of the available media elements into a media composition.

Existing systems have adopted a variety of approaches to this problem. In some systems, users designate the specific locations that contain the media elements to be made available, and the system then provides an indication of such designated media elements in a user interface. In other systems, a specific location is designated by the system, and media elements that are to be made available to the user must be placed in this specific location in order for the user to access them with the system. For example, such a location may be the root folder of each storage volume containing media assets.

With the growing complexity of media projects and modern distributed workflows, the management of media in existing systems is becoming increasingly cumbersome. New approaches for media management in video editing systems are required in order to keep pace with developments in the creative media industry.

### SUMMARY

In general, the methods, systems, and computer program products described herein enable media to be managed regardless of their storage locations on a media management and/or media editing system. The management functions include the automatic tracking and updating of references to the managed media stored in user-designated media-managed locations, as well as indexing, and the execution of predetermined media operations on the managed media when media files are added or changed.

In general, in one aspect, a computer system comprises: a CPU; a memory storing instructions for execution by the CPU, the instructions including a first set of instructions for implementing a media editing application on the computer system and a second set of instructions for enabling management of time-based media for use in creating a media composition with the media editing application, wherein, upon execution of the first and second sets of instructions, the computer system: stores in the memory an index for indexing a plurality of media files stored in a plurality of storage directories specified by a user of a media editing system, the index comprising a plurality of entries, each entry of the plurality of entries corresponding to a different media file of the plurality of media files, the entry for a given media file of the plurality of media files comprising: an identifier that uniquely identifies the given media file; a pointer to a storage location of a metadata file that includes metadata pertaining to the given media file, wherein the metadata file is adapted to the media editing system such that the media editing system is able to read the metadata file and use information from the metadata file to present to a user of the media editing system a descriptive indication of the given media file; and a pointer to a storage location of the given media file; wherein, in response to changes made to a content of one or more of the plurality of storage directories, the computer system automatically updates the index so that the plurality of entries reflect a current state of the plurality of media files stored in the plurality of storage directories.

Various embodiments include one or more of the following features. The index and the metadata file are stored in a common directory or in different storage directories. At least one of the plurality of storage directories includes a plurality of sub-directories that include media files, and the automatic updating of the index includes updating storage locations in the index when a change in an internal organization of media files within a managed storage directory is made. At least one of the plurality of storage directories is located on a second computer system. At least one of the plurality of storage directories is located on remote storage in data communication with the computer system via a wide area network. In response to a change in the index reflecting a change in a directory entry for a media file, a descriptive indication of the changed media file that is presented to the media editing system user is updated to reflect the change. A new media file is added to a first one of the plurality of storage directories, and automatically updating the index includes adding a new entry in the index corresponding to the new media file. One or more predetermined operations associated with the new media file are automatically performed when the new media file is added to a designated one of the plurality of storage directories. The predetermined operations include: transcoding the new media file to generate a new version of the media file and storing the new version of the media file; making a copy of the new media file and storing the copy in a storage location external to the first one of the plurality of storage directories; checking the new media file into a media asset management system; and ingesting one or more additional files and storing the one or more additional files in the first one of the plurality of storage directories. The predetermined operation includes making a copy of portions of media files in the first one of the plurality of storage directories that have been selected by the user for inclusion in the media composition, and storing the copy in a second storage directory.

In general, in another aspect, a method of managing a plurality of media files that are available to a user of a media editing system that displays an indication the plurality of media files available for creating a media composition includes: receiving input from the user designating a plurality of storage directories for storing media files that are to be managed; maintaining an index for the plurality of media files, the index comprising: a plurality of entries, each entry of the plurality of entries corresponding to a different media file of the plurality of media files, the entry for a given media file of the plurality of media files comprising: an identifier that uniquely identifies the given media file; a pointer to a storage location of a metadata file that includes metadata pertaining to the given media file, wherein the metadata file is adapted to the media editing system such that the media editing system is able to read the metadata file and use information from the metadata file to present to a user of the media editing system an indication of the given media file; and pointer to a storage location of the given media file; and for each storage directory of the designated storage directories: monitoring the storage directory; and if a change to a content of the storage directory is detected, automatically updating the index so that the plurality of entries reflects a current state of the plurality of media files stored in the plurality of storage directories.

Various embodiments include one or more of the following features. A new media file is stored in a first one of the plurality of storage directories, and automatically updating the index includes inserting a new entry into the index corresponding to the new media file, the new entry comprising: a unique identifier of the new media file; a pointer to a storage location of a metadata file pertaining to the new media file; and a pointer to a storage location of the new media file. The media editing system uses the updated index to display an indication of the new media file.

In general, in a further aspect, a method of managing media files for use with a media editing system that displays an indication of media files that are available to a user of the media editing system comprises: receiving input from a user of the media editing system designating one or more directories for storing media files that are to be managed; maintaining an index for the designated one or more directories, wherein each entry of a plurality of entries in the index corresponds to a media file stored in one of the one or more designated directories and each entry of the multiple entries in the index comprises: a unique identifier for the media file; a pointer to a storage location of a metadata file comprising metadata pertaining to the media file; and a pointer to a storage location of the media file; monitoring the designated one or more directories; if a change within in a directory of the one or more designated directories is detected, updating the index to reflect the change within the directory; and wherein in response to the updating of the index, the media editing system uses the index to update the display of the media files that are available to the user to reflect the detected change.

In some embodiments, the detected change within a directory of the one or more designated directories includes an addition of a new media file to one of the one or more directories, and the method further involves: generating a new media metadata file pertaining to the new media file; storing the new media metadata file; and inserting a new entry into the index corresponding to the new media file, the new entry comprising: a unique identifier of the new media file; a pointer to a storage location of the new media metadata file; and a pointer to a storage location of the new media file.

In general, in yet another aspect, a method of monitoring media files that are available to a user of a media editing system comprises: receiving input at the media editing system designating one or more directories that are to be monitored for media files; maintaining an index for the designated one or more directories, wherein each media file of the plurality of media files stored in one of the designated directories has a corresponding entry in the index, the entry comprising: a unique identifier for the media file that corresponds to the entry, a pointer to a storage location of a metadata file comprising metadata pertaining to the media file; and a pointer to a storage location of the media tile; if a change within a directory of the one or more designated directories is detected, updating the index to reflect the change within the directory; and wherein the media editing system monitors the index, and, in response to the updating of the index, updates a display of media files that are available to the user.

Various embodiments include one or more of the following features. The one or more directories include directories located on a storage device of the media editing system. The directories are located on storage external to the media editing system such as on shared storage in data communication with the media editing system via a local area network, or on remote storage in data communication with the media editing system via a wide area network. If the change within a directory of the one or more designated directories includes at least one of adding a new media file or changing a previously stored file, the method further includes executing one of a plurality of predetermined operations on the new media file or on the previously stored file.

### BRIEF DESCRIPTION OF THE DRAWINGS

FIG. 1 is a high level diagram of a media editing system including managed media directories on local, shared, and remote storage.

FIG. 2 is a simplified diagram of an index for managed media in a media management and editing application.

### DETAILED DESCRIPTION

The systems, methods, and computer program products described herein provide flexible and scalable support for managing media during the various phases of creating and editing a media composition. As used herein, media refers to time-based media such as video and audio, but for clarity the description focuses mainly on video production. A “media element” refers to media stored in a distinct media file. This may correspond to a video clip, an audio clip, or graphics for a special effect. Metadata associated with the media elements may be placed in a separate file.

Unless media are managed as described herein, media management and editing applications are only made aware of the media elements and able to work with them during the editing process either if they are in a pre-specified fixed location, or if a direct link to the media file has been provided explicitly by a user. The ability to provide direct links to an arbitrary location frees the user from the requirement to place the media in the pre-specified location on the system. Such flexibility is advantageous, and meshes well with the distributed workflows that characterize many medium to large sized media projects. However, since the media is not managed, the link to such media is lost if the media is moved to a different location, or the file name or folder name is changed in any way that affects the pathname. This inability to re-link automatically to a new location after media is moved is inconvenient, and can cause the user to expend effort rebuilding links when data is moved or reorganized. This can arise, for example when a user moves media between different classes of storage, such as a portable hard drive of linked media elements from one stand-alone system to another. Furthermore, any changes that are made to the media after the link has been provided are not monitored, with the result that the media application is unaware of the changes, and users may inadvertently find themselves working with incomplete or obsolete media elements.

In the system described herein, all media is managed in the sense described above, regardless of the media location. A user of the media management and editing application is able to designate any media accessible to the system, whether located on local or on remote storage, as managed media. Furthermore, the locations that are designated for managed media are monitored for activity, and the media editing system is continually made aware of changes. This brings the benefits of managed media to the user, without being required to place the media in a pre-specified location on the system.

In the system described here, users are able to designate the storage locations which contain media that is to be managed. The various aspects of what is meant by “managed media” are described in detail below. At a high level, media that is managed is made available to a user of a media editing system such that an up-to-date representation of the media is provided to the user as part of the media editing system's user interface, and via this interface, the user is able to access and manipulate the various elements of the managed media, and incorporate the elements or portions thereof into a media composition that is being produced. The user is also able to play back a version of the available media elements, either individually, or as part of a version of the composition being edited, in which the element may be combined with other elements and processed to produce a video or audio effect.

The storage locations that are identified as “media-managed” locations may be directories or folders into which one or more media items can be placed. Media may be placed into a managed directory or folder by a user action, such as copying a file into a managed location, or by a system creating and saving a media file into a managed location. Various automated or semi-automated processes for adding media files may be deployed, collectively referred to here at ingest processes. Once inside a managed directory or folder, a media element is managed.

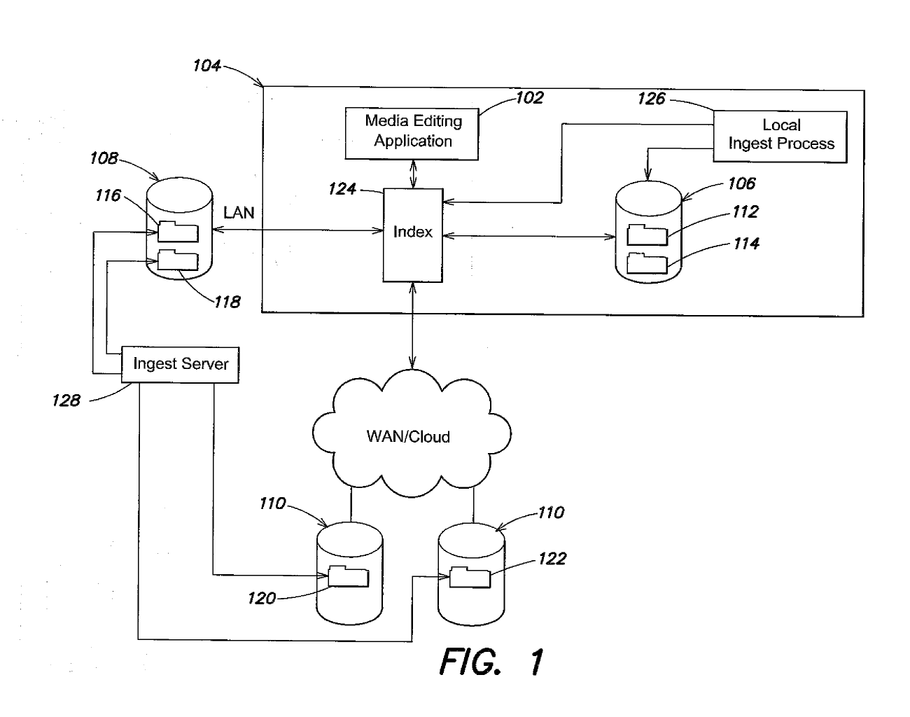

FIG. 1 is a high level diagram of a system with multiple user-designated locations for managed media. Media editing application 102 is hosted on computer system 104, which may be a workstation or a thin client. System 104 includes internal storage 106, which may be a hard drive or any other kind of read/write storage implemented by one or more storage devices. The system is also in data communication with local shared storage 108 via a local area network. In addition, the system may be connected to storage 110 hosted in the cloud. A user of media editing application 102 is able to designate locations, such as directories or folders within each of these storage devices for the placement of media that is to be managed in the sense described herein. For example, media-managed locations may include directories 112 and 114 in internal storage 106, directories 116 and 118 in shared storage 108, and directories 120 and 122 in cloud-hosted storage 110. The media editing application obtains current storage locations and information about all the media contained in all the media-managed locations via index 124. Media may be added to managed media locations 112 and 114 within system 104 by local ingest process 126, and to external managed locations 116, 118, 120, 122 by ingest server 128. In general, a user designates the location where the ingested media is to be stored.

Media management of designated locations includes the following functions: indexing the media stored in the designated locations; monitoring the designated locations; generating and maintaining a link to a metadata file corresponding to each media element within the managed locations; and performing various automated actions upon media when media is added to a managed media location or when media within a managed location is changed. We now describe each of these aspects in detail.

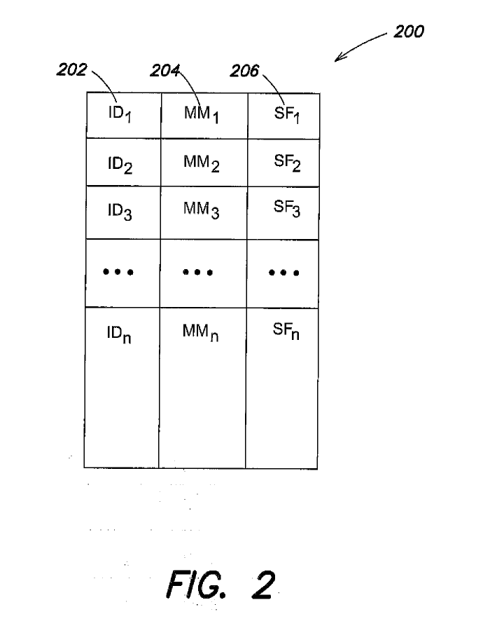

Media indexing refers to generating an index that associates a unique identifier for each media element (e.g., media file) in a managed location with a metadata file for that media element and with the location of the media element itself. Index 200 may be structured as indicated in FIG. 2. Each entry in the index is keyed by unique identifier, indicated as ID₁ (202), ID₂, and ID₃ for each of the first three entries in the illustrated index. The unique identifier may be a number specially generated for the media element that is long enough to virtually guarantee that it will be unique. It may be generated when the media element is created, e.g., by a camera or other media capture device, or it may be added later.

Associated with each unique identifier (i.e., each index entry) in index 200 are pointers to (i) a media metadata file for the media element identified by the unique identifier; and (ii) a source media file that includes the media essence of the media element. Thus, for example, ID₁ (202) is associated with a pointer to media metadata file MM₁ 204 and a pointer to source media file SF₁ 206. Index 200 is stored in a location accessible by the media editing system. In various embodiments the media metadata files (MMₙ) are stored in a common directory or folder as the index, or in another location that does not share a directory or a folder with the index. The pointers that are stored may be a path and filename corresponding to the media files and the source media files.

When media editing application 102 has access to a global media index such as index 124 (FIG. 1), the application is able to locate all the media that has been placed in the designated locations without having recourse to the file system.

Using the index, the media editing application accesses the media metadata files to retrieve information that it uses to display an indication of the corresponding media element to the user, typically in a displayed “bin” window of a graphical user interface. When the user wishes to play back a media element, the editing application accesses the corresponding media via the source file pointer in the index (e.g., SF₁ 206). In various embodiments, the source media is retrieved by a plug-in software component that converts the source media into a suitable proxy format for viewing responsively in a player window of the video editing system without changing the source media file. The media metadata file may include descriptive information such as a file name, an indication of a source location, date, timecode, compression, and wrapper type from which the media was obtained (e.g., MXF), as well as structural information, such as the format of the media data. Any of this information is available to the media editing application for inclusion within the displayed indication of the corresponding media element. For example, the indication may include an iconic representation of the media element, together with the media element name (e.g., file name), with other descriptive and structural information available when the icon is selected. One type of media metadata file is referred to as an AAF file (Advanced Authoring Format).

As mentioned above, media management includes the monitoring of the locations that have been designated for managed media. The system watches the designated locations for any activity. How the monitoring is performed depends on the operating system and file system that manages the storage locations and how the indexer can communicate with the operating system and the file system. Methods of monitoring activity for media indexing purposes are described in U.S. Pat. No. 8,001,088, which is wholly incorporated herein by reference. In this reference, a separate media indexer generates and maintains a separate index for each individual storage location. For example, each computer in a distributed multi-user system may have its own media indexer. Thus in order for a media editing system to be aware of media stored in a particular storage location, the media editing system needs to be made aware of the index associated with that location. By contrast, the present system creates and maintains a single global index to all the media that is stored in all of the designated storage locations. In addition, each of the storage locations is chosen by the user based on their preferences and workflows, rather than being in a specific location that is predetermined by the video editing system. This applies to local storage within the system hosting the media editing application (e.g., FIG. 1, 102), shared storage on a local area network (e.g., FIG. 1, 108), and cloud-hosted storage or other remote storage (e.g., FIG. 1, 120, 122).

When activity in a storage location that is designated as a managed media location is detected, index 200 is updated to reflect changes consequent upon that activity. For example, if a new media element is added to a designated location, a new entry corresponding to that element is added to the index. This involves retrieving (or generating) a unique identifier for the added media element, generating a media metadata file corresponding to the element, storing the media metadata file at a chosen location, and adding a pointer to that location in the new index entry. Finally, it involves retrieving the storage location of the media element itself, and adding that to the index as part of the new entry. Other changes to a managed media location that are monitored include: removing a media file, editing a media file, changing the file structure within a managed location, such as adding a new subdirectory or subfolder; moving a media element between subdirectories or folders; and converting a media element from one form, to another, such as making a proxy version. For any such change, the index is updated so that it remains an accurate and complete index to the current state of the media in the managed locations.

A further aspect of media management involves the ability to automatically perform one or more actions when activity is reported in a managed media location. Such actions may be specified in the form of rules. The following are some examples of actions that may be triggered in this manner. Automatic transcoding may be performed when a media element is added to a managed location. For example if an HD 1024p video clip is added to a managed folder, the system may generate a DN×HD proxy version and store that in the same folder. The added media element may be moved to another storage device or location, or copied, and the copy stored on another storage device or location. When removable storage is connected to the editing application, certain media files stored on the removable storage may be copied to a managed location on another storage device so as to free up the removable media. Newly added media may be checked into a production asset management system or a media asset management system. When multiple files are to be added to managed locations, a queued ingest process may be executed. For example, media captured during a day of shooting may be ingested as a batch and adding this media to a managed media location may also trigger processing into proxy files for use during editing. Another automated action may be consolidation of the managed media. This involves making copies of portions of media elements that have been included within a media composition, and storing the copies on another system. A further automated feature may include performing a speech-to-text conversion of a voice audio track to produce a searchable rough transcript.

The media management methods described herein may also be deployed with other applications for generating documents or media that include separate “daughter” media or documents that are stored in separate files. For example, in existing word processing systems, when an image is inserted into the document, the image is copied and embedded into the document. Links to the daughter file comprise hard-coded path names. If the location of a daughter file is changed, the link is broken, and the user would be asked to reimport the daughter file. This problem is resolved by placing daughter files in a location that is managed with respect to the word processing application, in the same manner described above in connection with media editing applications and the media being edited. Using managed locations, automatic relinking takes place when the daughter file is moved, and the parent document is still able to access the daughter file without reimporting the daughter file. Other examples include image processing applications and the raw images they operate upon, or spreadsheet applications in which a cell in a spreadsheet points to an external spreadsheet.

The various components of the system described herein may be implemented as a computer program using a general-purpose computer system. Such a computer system typically includes a main unit connected to both an output device that displays information to a user and an input device that receives input from a user. The main unit generally includes a processor connected to a memory system via an interconnection mechanism. The input device and output device also are connected to the processor and memory system via the interconnection mechanism.

One or more output devices may be connected to the computer system. Example output devices include, but are not limited to, liquid crystal displays (LCD), plasma displays, various stereoscopic displays including displays requiring viewer glasses and glasses-free displays, cathode ray tubes, video projection systems and other video output devices, printers, devices for communicating over a low or high bandwidth network, including network interface devices, cable modems, and storage devices such as disk or tape. One or more input devices may be connected to the computer system. Example input devices include, but are not limited to, a keyboard, keypad, track ball, mouse, pen and tablet, touchscreen, camera, communication device, and data input devices. The invention is not limited to the particular input or output devices used in combination with the computer system or to those described herein.

The computer system may be a general purpose computer system, which is programmable using a computer programming language, a scripting language or even assembly language. The computer system may also be specially programmed, special purpose hardware. In a general-purpose computer system, the processor is typically a commercially available processor. The general-purpose computer also typically has an operating system, which controls the execution of other computer programs and provides scheduling, debugging, input/output control, accounting, compilation, storage assignment, data management and memory management, and communication control and related services. The computer system may be connected to a local network and/or to a wide area network. such as the Internet. The connected network may transfer to and from the computer system program instructions for execution on the computer, media data such as video data, still image data, or audio data, metadata, review and approval information for a media composition, media annotations, and other data.

A memory system typically includes a computer readable medium. The medium may be volatile or nonvolatile, writeable or nonwriteable, and/or rewriteable or not rewriteable. A memory system typically stores data in binary form. Such data may define an application program to be executed by the microprocessor, or information stored on the disk to be processed by the application program. The invention is not limited to a particular memory system. Time-based media may be stored on and input from magnetic, optical, or solid state drives, which may include an array of local or network attached disks.

A system such as described herein may be implemented in software, hardware, firmware, or a combination of the three. The various elements of the system, either individually or in combination may be implemented as one or more computer program products in which computer program instructions are stored on a computer readable medium for execution by a computer, or transferred to a computer system via a connected local area or wide area network. Various steps of a process may be performed by a computer executing such computer program instructions. The computer system may be a multiprocessor computer system or may include multiple computers connected over a computer network. The components described herein may be separate modules of a computer program, or may be separate computer programs, which may be operable on separate computers. The data produced by these components may be stored in a memory system or transmitted between computer systems by means of various communication media such as carrier signals.

Having now described an example embodiment, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

What is claimed is:

1. A computer system comprising:
a CPU;
a memory storing instructions for execution by the CPU, the instructions including a first set of instructions for implementing a media editing application on the computer system and a second set of instructions for enabling management of time-based media for use in creating a media composition with the media editing application, wherein, upon execution of the first and second sets of instructions, the computer system:
stores in the memory an index for indexing a plurality of media files stored in a plurality of storage directories specified by a user of a media editing system, the index comprising a plurality of entries, each entry of the plurality of entries corresponding to a different media file of the plurality of media files, the entry for a given media file of the plurality of media files comprising:
an identifier that uniquely identifies the given media file;
a pointer to a storage location of a metadata file that includes metadata pertaining to the given media file, wherein the metadata file is adapted to the media editing system such that the media editing system is able to read the metadata file and use information from the metadata file to present to a user of the media editing system a descriptive indication of the given media file; and
a pointer to a storage location of the given media file;
wherein, in response to changes made to a content of one or more of the plurality of storage directories, the computer system automatically updates the index so that the plurality of entries reflect a current state of the plurality of media files stored in the plurality of storage directories.

2. The computer system of claim 1, wherein the index and the metadata file are stored in a common directory.

3. The computer system of claim 1, wherein the index and the metadata file are stored in different storage directories.

4. The computer system of claim 1, wherein at least one of the plurality of storage directories includes a plurality of sub-directories that include media files, and the automatic updating of the index includes updating storage locations in the index when a change in an internal organization of media files within the at least one of the plurality of storage directories is made.

5. The computer system of claim 1, wherein at least one of the plurality of storage directories is located on a second computer system.

6. The computer system of claim 1, wherein at least one of the plurality of storage directories is located on remote storage in data communication with the computer system via a wide area network.

7. The computer system of claim 1, wherein in response to a change in the index reflecting a change in a directory entry for the given media file, a descriptive indication of the given media file presented to the media editing system user is updated to reflect the change.

8. The computer system of claim 1, wherein a new media file is added to a first one of the plurality of storage directories, and automatically updating the index includes adding a new entry in the index corresponding to the new media file.

9. The computer system of claim 8, further comprising automatically performing a predetermined operation associated with the new media file.

10. The computer system of claim 9, wherein the predetermined operation is one of the set consisting of:
transcoding the new media file to generate a new version of the media file and storing the new version of the media file;
making a copy of the new media file and storing the copy in a storage location external to the first one of the plurality of storage directories;
checking the new media file into a media asset management system; and
ingesting one or more additional files and storing the one or more additional files in the first one of the plurality of storage directories.

11. The computer system of claim 9, wherein the predetermined operation includes making a copy of portions of media files in the first one of the plurality of storage directories that have been selected by the user for inclusion in the media composition, and storing the copy in a second storage directory.

12. A method of managing a plurality of media files that are available to a user of a media editing system for creating a media composition, wherein the media editing system displays an indication the plurality of media files, the method comprising:
receiving input from the user designating a plurality of storage directories for storing media files that are to be managed;
maintaining an index for the plurality of media files, the index comprising:
a plurality of entries, each entry of the plurality of entries corresponding to a different media file of the plurality of media files, the entry for a given media file of the plurality of media files comprising:
an identifier that uniquely identifies the given media file;
a pointer to a storage location of a metadata file that includes metadata pertaining to the given media file, wherein the metadata file is adapted to the media editing system such that the media editing system is able to read the metadata file and use information from the metadata file to present to a user of the media editing system an indication of the given media file; and
a pointer to a storage location of the given media file; and
for each storage directory of the designated storage directories:
monitoring the storage directory; and
if a change to a content of the storage directory is detected, automatically updating the index so that the plurality of entries reflects a current state of the plurality of media files stored in the plurality of storage directories.

13. The method of claim 12, wherein a new media file is stored in a first one of the plurality of storage directories, and wherein automatically updating the index includes inserting a new entry into the index corresponding to the new media file, the new entry comprising:
a unique identifier of the new media file;
a pointer to a storage location of a metadata file pertaining to the new media file; and
a pointer to a storage location of the new media file.

14. The method of claim 12, further comprising the media editing system using the updated index to display an indication of the new media file.

15. A method of managing media files for use with a media editing system, wherein the media editing system displays an indication of media files that are available to a user of the media editing system, the method comprising:
receiving input from a user of the media editing system designating one or more directories for storing media files that are to be managed;
maintaining an index for the designated one or more directories, wherein each entry of a plurality of entries in the index corresponds to a media file stored in one of the one or more designated directories and each entry of the multiple entries in the index comprises:
a unique identifier for the media file;
a pointer to a storage location of a metadata file comprising metadata pertaining to the media file; and
a pointer to a storage location of the media file;
monitoring the designated one or more directories;
if a change within in a directory of the one or more designated directories is detected, updating the index to reflect the change within the directory; and
wherein in response to the updating of the index, the media editing system uses the index to update the display of the media files that are available to the user to reflect the detected change.

16. The method of claim 15, wherein the detected change within a directory of the one or more designated directories includes an addition of a new media file to one of the one or more directories, and further comprising:
generating a new media metadata file pertaining to the new media file;
storing the new media metadata file; and
inserting a new entry into the index corresponding to the new media file, the new entry comprising:
a unique identifier of the new media file;
a pointer to a storage location of the new media metadata file; and
a pointer to a storage location of the new media file.

17. A method of monitoring media files that are available to a user of a media editing system, the method comprising:
receiving input at the media editing system designating one or more directories that are to be monitored for media files;
maintaining an index for the designated one or more directories, wherein each media file of the plurality of media files stored in one of the designated directories has a corresponding entry in the index, the entry comprising:
a unique identifier for the media file that corresponds to the entry;
a pointer to a storage location of a metadata file comprising metadata pertaining to the media file; and
a pointer to a storage location of the media file;
if a change within a directory of the one or more designated directories is detected, updating the index to reflect the change within the directory; and
wherein the media editing system monitors the index, and, in response to the updating of the index, updates a display of media files that are available to the user.

18. The method of claim 17, wherein the one or more directories include directories located on a storage device of the media editing system.

19. The method of claim 17, wherein the one or more directories include directories located on at least one of
shared storage in data communication with the media editing system via a local area network: and
remote storage in data communication with the media editing system via a wide area network.

20. The method of claim 17, wherein if the change within a directory of the one or more designated directories includes at least one of adding a new media file or changing a previously stored file, executing one of a plurality of predetermined operations on the new media file or on the previously stored file.
